(19) United States
(12) Patent Application Publication
(10) Pub. No.: US 2026/0089785 A1
(43) Pub. Date: Mar. 26, 2026

(54) User Equipment, Network Node, and Methods for Handling Communications

(71) Applicant: Telefonaktiebolaget LM Ericsson (publ), Stockholm (SE)

(72) Inventors: Lian Araujo, Solna (SE); Alessio Terzani, Stockholm (SE); Muhammad Ali Kazmi, Sundbyberg (SE); Tahmineh Torabian Esfahani, Sollentuna (SE)

(21) Appl. No.: 19/111,379

(22) PCT Filed: Sep. 15, 2023
(86) PCT No.: PCT/SE2023/050905

§ 371 Date: Mar. 13, 2025

Related U.S. Application Data
(60) Provisional application No. 63/375,857, filed on Sep. 16, 2022.

(51) Int. Cl. H04W 76/16; H04W 8/18; H04W 36/00

(52) U.S. Cl. CPC H04W 76/16; H04W 8/183; H04W 36/0069

(57) ABSTRACT

A method performed by a UE (102) having at least two SIMs for simultaneous communication with two or more networks. The UE provides assistance information to a network node, wherein the assistance information is related to a MCG, and/or SCG; and the assistance information indicates a preference for reduced UE configuration for Multi-SIMs purposes.

### TECHNICAL FIELD

Embodiments herein relate to a user equipment (UE), a network node, and methods performed therein regarding wireless communication. Furthermore, a computer program product and a computer-readable storage medium are also provided herein. In particular, embodiments herein relate to handling communication, such as handling operation of a multi-Subscriber Identity Module (SIM) user equipment.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node, e.g., a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE, and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 6G networks and development of 5G such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies, such as NR, the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Next generation systems are expected to support a wide range of use cases with varying requirements ranging from fully mobile devices to stationary internet of things (IoT) or fixed wireless broadband devices. The traffic pattern associated with many use cases may be expected to consist of short or long bursts of data traffic with varying length of waiting period in between, here called inactive state. In NR, both license-assisted access and standalone unlicensed operation are to be supported. Hence, the procedure of Physical Random Access Channel (PRACH) transmission and/or Scheduling Request (SR) transmission in unlicensed spectrum may be investigated in 3GPP.

Multiple Subscriber Identity Modules (SIM), or “Multi-SIMs”, devices are devices which enable use of multiple subscriptions in one device using more than one SIM also referred to as Universal Subscriber Identity Modules (USIM). Multi-SIMs UEs can support concurrent registration to more than one network simultaneously and, e.g., if a UE has two different radios implemented, such as both dual receive (Rx) and dual transmit (Tx) capability, it would be possible for the UE to behave as two separate UEs and communicate with two networks at the same time. There are also dual or Multi-SIMs capable UEs that only have one single radio front-end and baseband processing.

3GPP is currently studying in Rel-17 how to best support UE's that can manage two or more simultaneous subscriptions, also called Multi-USIM. A single UE is capable of having two or more subscription credentials and basically to “act” as two UEs within one device/hardware entity. Even though mobile terminals with that property exist, most operations are not really optimized as there is no specific standardized support for Multi-USIM, e.g., make it easier for UEs to manage two or more subscriptions simultaneously.

Several aspects may be addressed. For example, a UE may need to be provided support to easier switch between states related to utilization of subscription 1, e.g., USIM1 connecting to a Public Land Mobile Network1 (PLMN1), and states related to utilization or communication using subscription 2, e.g., USIM2, connecting to PLMN2, as such states may be dependent, e.g. RRC_CONNECTED in PLMN1 and PLMN2. Such switching may be straightforward, or maybe not even necessary, if the UE has the capability of communicating simultaneously towards two networks, using USIM1 and 2 simultaneously. For this to work, there may be a need for at least dual receiver and transmitter chains, that frequencies that are used towards both networks don't cause interference to each other and that radio separation is good enough to not cause, e.g., Inter-Modulation (IM) effects in the device. Yet other aspects that can be addressed by standard is to introduce a signaling that allows a UE that cannot simultaneously communicate with, e.g., two or more networks, to at least signal a network that it is leaving, or becoming unreachable for that network.

As described in [1], the Rel-17 work on Multi-USIM includes the following objectives:
1. Specify, if necessary, enhancement(s) to address the collision due to reception of paging when the UE is in RRC_IDLE/RRC_INACTIVE mode in both the networks associated with respective SIMs [RAN2]
   a. RAT Concurrency: Network A can be NR or LTE. Network B can either be LTE or NR.
   b. Applicable UE architecture: Single-Rx/Single-Tx.
2. Specify mechanism for UE to notify Network A of its switch from Network A (for Multi-USIM (MUSIM) purpose) [RAN2]:
   a. RAT Concurrency: Network A is NR. Network B can either be LTE or NR.
   b. Applicable UE architecture: Single-Rx/Single-Tx, Dual-Rx/Single-Tx
3. Unless SA2 finds an alternative solution or decides otherwise, specify mechanism for an incoming page to indicate to the UE whether the service is Voice over LTE (VoLTE)/Voice over NR (VoNR) [RAN2].
   a. RAT Concurrency: Network A is either LTE or NR. Network B is either LTE or NR.
   b. Applicable UE architecture: Single-Rx/Dual-Rx/Single-Tx

### Dual Connectivity Options

In TS 36.300 v.17.0.0, dual connectivity is defined for intra-E-UTRA Dual Connectivity (DC) as depicted in FIG. 1a, which highlights the control (C)-plane and user (U)-Plane connectivity. Both MeNB and SeNB are E-UTRA nodes, with an EPC CN entity.

FIG. 1 shows C-Plane and U-Plane connectivity of eNBs involved in DC.

In TS 37.340 v.17.0.0, DC is further defined for Multi-RAT Dual Connectivity (MR-DC), which implies in having a UE configured with two different nodes—one providing E-UTRA access and the other one providing NR access. The CN entity associated to MR-DC can be either EPC or 5GC, which divides MR-DC cases in:
E-UTRA-NR Dual Connectivity (EN-DC), comprised in EPS, as a master node (MN) eNB and an en-gNB as a secondary node (SN) (en-gNB refers to a gNB that is operating in a non standalone mode operating as the SN);
NG-RAN E-UTRA-NR Dual Connectivity (NGEN-DC), comprised in 5GS, as a MN ng-eNB (ng-eNB refers to LTE eNB connected to 5GC) and a gNB as the SN;
NR-E-UTRA Dual Connectivity (NE-DC), comprised in 5GS, as a MN gNB and an ng-eNB as the SN;

A gNB or ng-eNB are collectively referred to as NG-RAN node.

C-plane and U-Plane connectivity for EN-DC case is depicted in FIG. 1b, MR-DC case associated with 5GC is depicted in FIG. 1c.

FIG. 1c shows C-Plane and U-Plane connectivity of MR-DC with 5GC.

Besides MR-DC definition, the dual connectivity case where the MN and SN are NR nodes is called NR-NR-DC, which is agreed in RAN 2 meeting to be covered in TS 37.340. C-plane and U-Plane connectivity for NR-NR-DC can be depicted by FIG. 1c, as in the case of MR-DC associated with 5GC.

### SUMMARY

As part of developing embodiments herein one or more problems were first identified. In the current framework for Multi-USIM study in Rel-17, it is assumed that the UE is not able to stay in RRC_CONNECTED in two networks simultaneously, e.g., it is not possible for the UE to receive/send data using one subscription while having an ongoing service with another subscription. For UEs with at least dual Tx and dual Rx, when reporting UE capabilities, the available resources may be under-utilized especially in case of MR-DC.

An object herein is to provide improved handling of operation of a Multi-SIMs UE.

Embodiments herein provide methods and triggers for the UE to indicate or provide a preference to temporarily reduce UE capabilities for multiple SIMs purposes in e.g., MR-DC, when the UE is simultaneously in RRC_CONNECTED mode with multiple networks.

According to an aspect of the present disclosure, the object is achieved by providing a method performed by a UE having at least two SIMs for simultaneous communication with two or more networks. The UE provides to a network node assistance information related to Master Cell Group (MCG) and/or Secondary Cell Group (SCG); and assistance information indicating, or concerning, a preference, or capability, for reduced UE configuration for Multi-SIMs purposes.

According to an aspect of the present disclosure, the object is achieved by providing a method performed by a network node associated with a wireless communications network. The network node receives from the UE, assistance information related to MCG and/or SCG; and assistance information indicating a preference or capability for reduced UE configuration for Multi-SIMs purposes.

According to a further aspect of the present disclosure, the object is achieved by providing the UE having multiple SIMs for simultaneous communication with two or more networks, wherein the UE is configured to provide to the network node assistance information related to MCG and/or SCG; and assistance information indicating a preference for reduced UE configuration for Multi-SIMs purposes.

According to a further aspect of the present disclosure, the object is achieved by providing a network node associated with a wireless communications network,
wherein the network node is configured to receive from a UE, assistance information related to MCG and/or SCG; and assistance information indicating a preference for reduced UE configuration for Multi-SIMs purposes.

It is furthermore provided herein a computer program product comprising instructions, which, when executed on at least one processor, cause the at least one processor to carry out the methods above, as performed by the UE and the network node, respectively. It is additionally provided herein a computer-readable storage medium, having stored thereon a computer program product comprising instructions which, when executed on at least one processor, cause the at least one processor to carry out the methods above, as performed by the UE and the network node, respectively.

The object is further achieved by providing a UE and a network node configured to perform the methods herein, respectively.

Embodiments herein allow supporting a UE dual connectivity in more than one network. The UE may stay in RRC_CONNECTED mode simultaneously on two or more networks, for multiple SIMs purposes. Embodiments herein enable the UE, in, for example, MR-DC, to be simultaneously in RRC_CONNECTED mode with multiple networks to adapt the configuration of the available radio resources to the UE's current needs and/or situation, e.g., maximizing the throughput for data transmission and/or reception using one subscription while having and/or maintaining a phone call with another subscription.

The methods also allow the UE to simultaneously operate in RRC_CONNECTED mode with multiple networks while still meeting the regulatory requirements related to radio exposure to humans.

### BRIEF DESCRIPTION OF THE DRAWINGS

Embodiments will now be described in more detail in relation to the enclosed drawings, in which:

FIG. 1a shows C-Plane and U-Plane connectivity of eNBs involved in Dual Connectivity according to prior art;

FIG. 1b shows C-Plane and U-Plane connectivity of EN-DC according to prior art;

FIG. 1c shows C-Plane and U-Plane connectivity of MR-DC with 5GC according to prior art;

FIG. 2a is a schematic overview depicting a wireless communications network in accordance with embodiments herein;

FIG. 2b is a combined signalling scheme and flowchart, showing communications between a UE and first and second network nodes, in accordance with embodiments herein;

FIG. 3a is a schematic flowchart illustrating a method performed by a UE, in accordance with embodiments herein;

FIG. 3b is a schematic flowchart illustrating a method performed by a network node, in accordance with embodiments herein;

FIG. 4 is a combined signalling scheme and flowchart, showing communications between a UE and first and second network nodes, in accordance with some embodiments;

FIG. 5 is a schematic overview depicting a UE in accordance with some embodiments;

FIG. 6 is a schematic overview depicting a network node in accordance with some embodiments;

FIG. 7 illustrates a telecommunication network connected via an intermediate network to a host computer, in accordance with some embodiments;

FIG. 8 illustrates a host computer communicating via a base station with a user equipment over a partially wireless connection, in accordance with some embodiments;

FIG. 9 is a flowchart illustrating methods implemented in a communication system including a host computer, a base station, and a user equipment, in accordance with some embodiments;

FIG. 10 is another flowchart illustrating methods implemented in a communication system including a host computer, a base station, and a user equipment, in accordance with some embodiments;

FIG. 11 is another flowchart illustrating methods implemented in a communication system including a host computer, a base station, and a user equipment, in accordance with some embodiments; and

FIG. 12 is another flowchart illustrating methods implemented in a communication system including a host computer, a base station, and a user equipment, in accordance with some embodiments.

### DETAILED DESCRIPTION

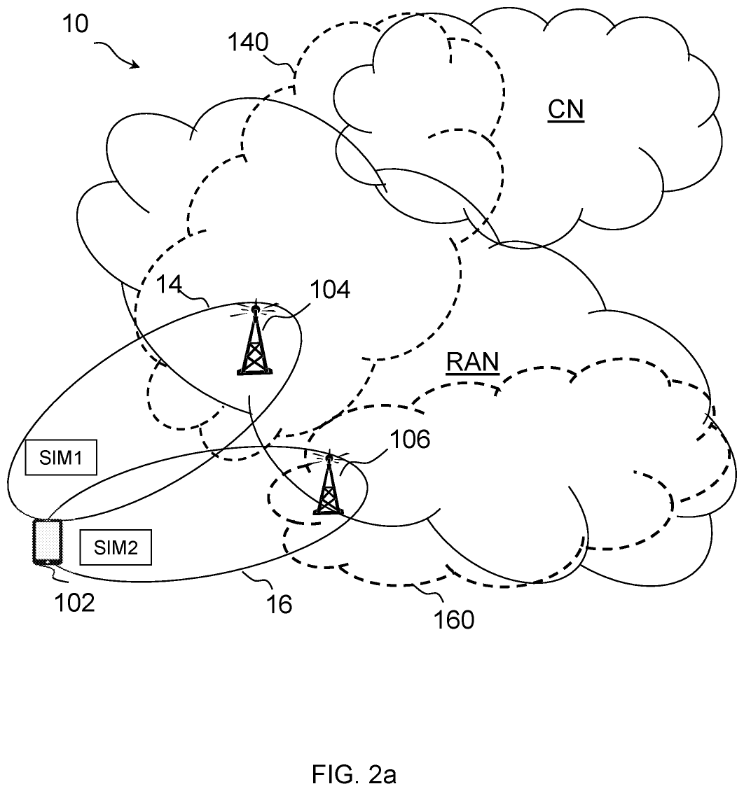

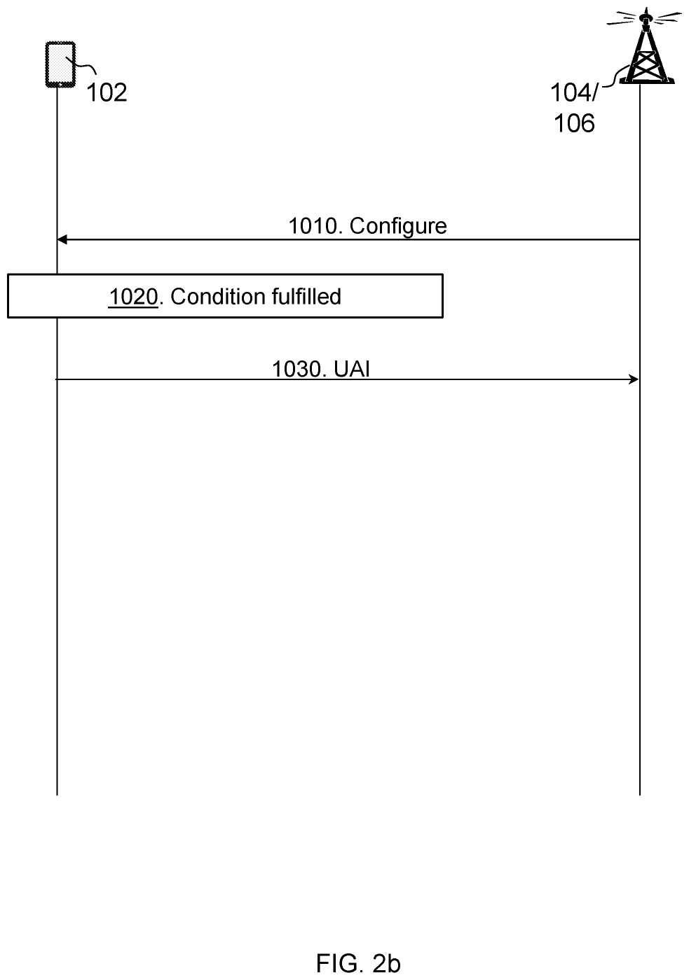

Embodiments herein relate to wireless communications networks in general. FIG. 2a is a schematic overview depicting a wireless communications network 10. The wireless communications network 10 comprises one or more RANs and one or more CNs. The wireless communications network 10 may use one or a number of different technologies. Embodiments herein relate to recent technology trends that are of particular interest in a New Radio (NR) context, however, embodiments are also applicable in further developments of existing wireless communications systems such as e.g. LTE or Wideband Code Division Multiple Access (WCDMA).

In the wireless communications network 10, a user equipment (UE) 102, such as a mobile station, a wireless device, a non-access point (non-AP) STA, a STA, and/or a wireless terminal, is communicating via e.g. one or more Access Networks (AN), e.g. RAN, to one or more CNs. It should be understood by the skilled in the art that “UE” is a non-limiting term which means any terminal, wireless communications terminal or device, user equipment, narrowband (NB)-IoT device, Machine Type Communication (MTC) device, Device to Device (D2D) terminal, or node, e.g. smart phone, laptop, mobile phone, sensor, relay, mobile tablets or even a small base station capable of communicating using radio communication with a radio network node within an area served by the radio network node.

The wireless communications network 10 comprises a first network node 104, e.g., an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point, or any other network unit or node capable of communicating with a wireless device within a service area 14 served by the first network node 104 depending e.g., on a radio access technology and terminology used. The service area 14 may also be referred to as a beam or a beam group of a first radio access technology (RAT), such as 5G, LTE, Wi-Fi, or similar. The first network node 104 may be associated with and provide radio communication in a first wireless communications network 140, such as, e.g., a first Public Land Mobile Network (PLMN) or a first Non-Public Network (NPN). In some embodiments, the first wireless communications network 140 may be implemented as a combination of a PLMN and an NPN.

The wireless communications network 10 also comprises a second network node 106, e.g., an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point, or any other network unit or node capable of communicating with a wireless device within a service area 16 served by the second network node 106 depending e.g., on a radio access technology and terminology used. The service area 16 may also be referred to as a beam or a beam group of a second RAT, such as 5G, LTE, Wi-Fi, or similar. The second network node 106 may be associated with and provide radio communication in a second wireless communications network 160, such as, e.g., a second PLMN or a second NPN. In some embodiments, the second wireless communications network 160 may be implemented as a combination of a PLMN and an NPN.

Embodiments of the present disclosure relate to Multi-SIM, or Multi-USIM, devices that can enable users to be registered to multiple networks, such as PLMNs, NPNs, or a combination thereof. For instance, UEs equipped with dual radio capabilities may enable simultaneous connection to two wireless communications networks.

As shown in FIG. 2a, the UE 102 may thus be a Multi-SIMs UE and it may have a first SIM, shown as SIM1, and a second SIM, shown as SIM2, though it should be appreciated that the UE 102 may have more than two SIMs. In the illustrated embodiment, the first wireless communications network 140, such as the first PLMN or NPN, is associated with the first SIM of the UE 102, and the second wireless communications network 160, such as the second PLMN or NPN, is associated with the second SIM of the wireless communication device.

In some embodiments, the UE 102 may be registered with both the first and second wireless communications networks 140, 160, which may be respective PLMNs, NPNs, a combination of PLMN(s) and NPN(s), or any other wireless communications networks that may be of the same or different types. As used herein, a PLMN is defined as a wireless communications network that provides a combination of wireless communication services offered by an operator. As used herein, an NPN is defined as a private network that is deployed for private use by an entity such as a government, company, or another entity. In some embodiments, when the UE 102 has multiple SIMs, the different SIMs are associated with different PLMNs or NPNs. In some embodiments, the UE 102 may have more than one SIM which is associated with the same network such as a PLMN and/or NPN, e.g., the UE 102 may have two SIMs from the same operator.

Some aspects of the present disclosure may be implemented in connection with the Radio Resource Control (RRC) protocol.

In some embodiments, aspects of the present disclosure may be implemented in a cloud environment.

The UE 102 may have more than one radio, such as, e.g., both dual receive (Rx) and dual transmit (Tx) capability. The radios may support RRC_CONNECTED mode in a network, e.g., one of the first and second wireless communications networks 140, 160, without interrupting service of the other network, e.g., the other one of the first and second wireless communications networks 140, 160.

The number of Rx/Tx radio chains may play a role on how Multi-SIMs UEs are managed. Furthermore, different possible network configurations and a changing demand for diverse types of operations may affect the complexity of handling communications of Multi-SIMs UEs, which may communicate with multiple wireless communications networks.

Throughout this document, network A and B may be referred as two networks where a Multi-SIMs UE, also referred to as Multi-USIM UE, is simultaneously in RRC_CONNECTED mode. But the solutions described below are also applicable to a case where the UE is connected to more than two networks and the person skilled in the art will appreciate how the methods would be performed in scenarios with more than two networks.

A UE may have multiple SIMs, or USIMs, and one use case for multiple SIMs is that the different SIMs are associated with different networks, where a network could be a PLMN or an NPN. However, it is also possible that a UE has more than one SIM, which is associated with the same network, e.g. a UE has two SIMs from the same operator. It will in some descriptions of the methods herein be used as example that the multiple SIMs are associated to different networks, but the methods can also be applied for the scenario where multiple SIMs are associated with the same network.

In the examples, PLMNs are used as examples, but without loss of generality these could be any kind of networks including NPNs.

Accordingly, embodiments of the present disclosure provide an improved way for the UE 102, such as a Multi-SIMs enabled UE, to indicate or provide a preference, or request, or capability, for reduced UE configuration for Multi SIMs purposes. Devices and methods in accordance with embodiments of the present disclosure enable the UE to be simultaneously in RRC_CONNECTED mode with multiple wireless communications networks to adapt the configuration of the available radio resources to the UE's current needs and/or situation, e.g., maximizing the throughput for data transmission and/or reception using one subscription while having and/or maintaining a phone call with another subscription.

According to aspects of the disclosure, a Multi-SIMs capable UE can communicate with two different networks simultaneously. Thus, for example, when the UE 102 is registered with PLMN1 and PLMN2, or other types of wireless communications networks, at the same time, the UE 102 may, as in the case when the UE 102 is registered with one network only, provide to a network node, assistance information related to MCG and/or SCG; and assistance information indicating a preference, or capability, for reduced UE configuration for Multi-SIMs purposes. The network node receiving the assistance information may be the first network node 104 or the second network node 106.

FIG. 2b is a combined flowchart and signalling scheme depicting some embodiments herein.

Action 1010. The network node, such as the first network node 104, may configure the UE 102 to provide assistance information related to MCG and/or SCG, and concerning a preference for reduced UE configuration for Multi-SIM, or USIM, purposes, and/or an indication of triggering such provision. It should be noted that the UE 102 may be preconfigured to perform the methods herein.

Action 1020. The UE 102 may detect whether a condition is fulfilled or not for providing assistance information related to MCG and/or SCG, and indicating a preference for reduced UE configuration for Multi-SIM, or USIM, purposes.

Action 1030. The UE 102 provides to the network node UE assistance information (UAI) related to MCG and/or SCG; and assistance information indicating a preference or a capability for reduced UE configuration for Multi-USIM purposes.

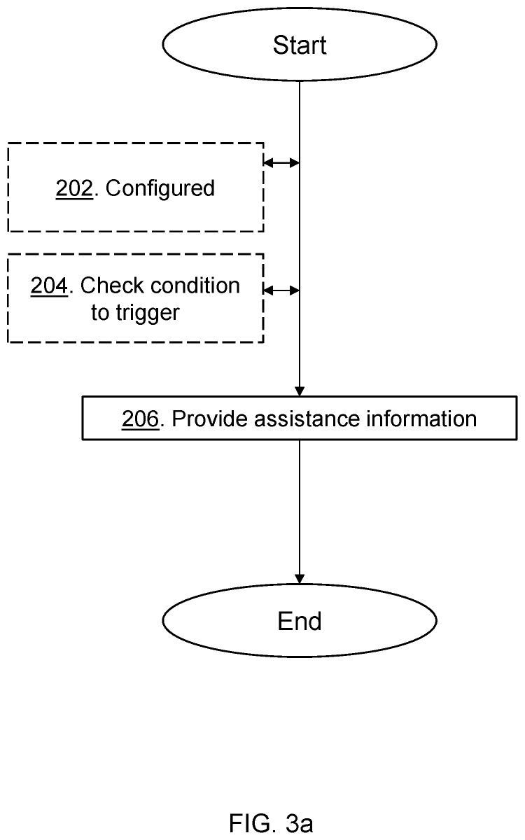

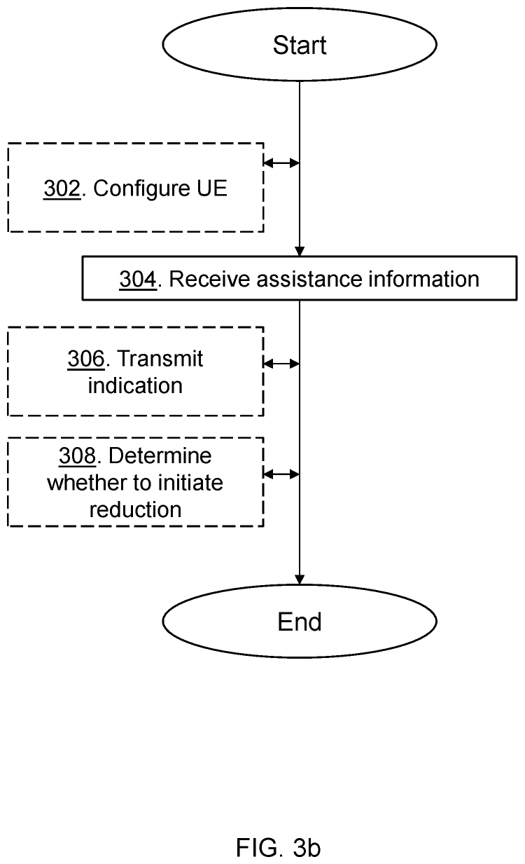

FIG. 3a illustrates an example of a method performed by the UE 102 having at least two SIMs for simultaneous communication with two or more networks according to embodiments herein. For example, FIG. 3a may illustrate a Multi-SIMs enabled UE, such as the UE 102, in accordance with embodiments of the present disclosure. The UE 102 has the first and second SIMs. In some embodiments, the UE has multiple SIMs, e.g., three, four, five, six, or more than six SIMs.

Optional actions are shown using a dashed line. The acts of FIG. 3a may be performed in any suitable order.

Action 202. The UE 102 may configure the UE 102 to provide the assistance information, and/or with one or more triggering conditions. Thus, the UE 102 may be configured by the network node, such as the first or the second network node 104/106, to provide the assistance information, and/or with the one or more triggering conditions. The UE 102 may configure the UE 102 to provide the assistance information, and/or with one or more triggering conditions by configuring the UE 102 to provide the assistance information related to MCG and/or SCG; and assistance information indicating a preference for reduced UE configuration for Multi-SIMs purposes; and/or an indication of triggering such provision of an indication of preference to reduce UE capabilities for

Multiple SIMs purposes in MR-DC, when the UE is simultaneously in RRC_CONNECTED mode with multiple networks.

Action 204. The UE 102 may check a condition, also referred to as triggering condition, to trigger sending the assistance information to the network node. The condition may define a change in a channel condition and/or a change of data demands. Thus, the UE 102 may check the condition to trigger sending the assistance information to the first wireless communications network. The UE 102 may be triggered to provide to the first network node 104 the assistance information in response to a change in at least one condition of the UE 102 in at least one of the first and second wireless communications networks 140 and 160, respectively, wherein the change in the at least one condition comprises a channel condition and/or a change of data demands. When a change in one or more conditions on the wireless communications network to which the UE is connected, such as the first wireless communications network 140 or the second wireless communications network 160, occurs, depending on different aspects related to the wireless communications network, the UE 102 may decide to trigger a UAI report or trigger to send an activation request, discussed below, for one or more elements provided in the UAI.

The at least one condition may comprise a channel condition. For example, the channel conditions for one of the wireless communications networks, e.g., the first wireless communications network 140, may have become worse while they were improved for another wireless communications network, e.g., the second wireless communications network 160. Thus, the UE 102 may report to the first wireless communications network 140 a preference for a reduced configuration while the UE 102 may report to the second wireless communications network 160 a preference for a configuration that provides improved conditions for communications between the UE 102 and the second wireless communications network 160, e.g., higher bandwidth, more component carriers, etc.

The at least one condition comprises a change of data demands in at least one of the first and second wireless communications networks 140 and 160, respectively. For example, while there may be low data demand for one of the wireless communications networks, e.g., the first wireless communications network 140, the UE 102 may report to the first wireless communications network 140 a preference for a reduced configuration, while the UE 102 may report to the second wireless communications network 160 a preference for a configuration that provides improved conditions for communications between the UE 102 and the second wireless communications network 160, e.g., higher bandwidth, more component carriers, etc.

The assistance information may be provided in response to an expiration of a timer. For example, the timer may be a timer to prohibit frequent reports sent by the UE 102, such that the UE 102 can only send another report, such as a UAI, or a trigger once the timer expires. The timer may operate with any suitable frequency, and the timer may be adjustable. In some embodiments, once a UAI is set, the timer may be reset.

The UE 102 provides the assistance information to the network node 104/106 in response to one or more out of, also referred to as one or more triggering conditions or as one or more conditions:
availability of information to be sent in the first request that is different from information previously sent in a prior request to the first network node 104 concerning a reduced set of capabilities;
an occurrence of an event;
an occurrence of network configured conditions;
a handover of the UE 102 from a source cell to a target cell;
a reconfiguration procedure other than a handover;
a connection setup;
a re-establishment procedure;
a resume procedure;
before the UE is suspended, i.e. moved to RRC_INACTIVE;
for a UE that is configured to provide assistance information on reduced UE configuration/capabilities for Multi-SIMs purposes, when the UE initiates RRC connection re-establishment procedure or when the UE initiates a RRC resume procedure, the configuration related with assistance information on reduced UE configuration for Multi-USIM purposes is released by the UE; and
if sending a UE assistance information message that does no longer include an indication of UE preference for a certain reduced UE configuration/capabilities for Multi-USIM purposes. As an example, if the UE has sent a UE assistance information message to the network with an indication of UE preference to have reduced MIMO layers, the transmission of a new UE assistance information message where this indication (of UE preference to have reduced MIMO layers) is not present corresponds to no longer having a preference on reduced MIMO layers.

Action 206. The UE 102 provides the assistance information to the network node, wherein the assistance information is related to the MCG, and/or the SCG; and the assistance information indicates the preference for reduced UE configuration for Multi-SIMs purposes. The UE 102 may provide, e.g., transmit, the assistance information to the network node such as the first network node 104 and/or the second network node 106.

Thus, the UE 102 may provide an indication of preference to reduce UE capabilities for multiple SIMs purposes in MR-DC, when the UE is simultaneously in RRC_CONNECTED mode with multiple networks. The UE may transmit the assistance information when being triggered in action 204.

The UE 102 may transmit the assistance information to the network node in response to one or more out of:
availability of information to be sent in the first request that is different from information previously sent in a prior request to the first network node 104 concerning a reduced set of capabilities;
an occurrence of an event;
an occurrence of one or more network configured conditions;
a handover of the UE 102 from a source cell to a target cell;
a reconfiguration procedure other than a handover;
a connection setup;
a re-establishment procedure;
a resume procedure;
before the UE is moved to RRC_INACTIVE;
for a UE that is configured to provide assistance information on reduced UE configuration/capabilities for Multi-SIMs purposes, when the UE initiates RRC connection re-establishment procedure or when the UE initiates a RRC resume procedure, the configuration related with assistance information on reduced UE configuration for Multi-SIMs purposes is released by the UE; and
if sending a UE assistance information message to another network node that does no longer include an indication of UE preference for a certain reduced UE configuration/capabilities for Multi-SIMs purposes.

The assistance information may comprise one or more of the following:
an indication of UE preference to have one or more serving cells activated;
an indication of UE preference to one or more serving cells deactivated;
an indication of a reduced configuration that the SCG is allowed to configure;
an indication of preferred UE power class as part of the reduced UE configuration to enable the UE to perform the Multi-SIMs operation.
an indication of UE preference of preferred maximum uplink duty cycle as part of the reduced UE configuration to enable the UE to perform the Multi-SIMs operation.
an indication indicating that the UE can perform the Multi-SIMs operation while still being configured with MR-DC, provided that the SCG is deactivated.

FIG. 3b illustrates an example of a method performed by a network node associated with a wireless communications network, such as any of the first and second network nodes 104, 106, for example, associated with first and second wireless communication networks 140, 160, respectively, in accordance with embodiments of the present disclosure. Any suitable network node may communicate with a UE, such as the UE 102, in accordance with embodiments of the present disclosure. Optional actions are shown using a dashed line. The acts in FIG. 3b may be performed in any suitable order.

The network node may be associated with the wireless communications network associated with a first SIM.

Action 302. The network node may configure the UE 102 to provide the assistance information related to MCG and/or SCG; and assistance information indicating a preference for reduced UE configuration for Multi-SIMs purposes; and/or an indication of triggering such provision of an indication of preference to reduce UE capabilities for multiple SIMs purposes in MR-DC, when the UE is simultaneously in RRC_CONNECTED mode with multiple networks. The network node may thus configure the UE 102 to provide the assistance information related to MCG and/or SCG; and assistance information concerning a preference for reduced UE configuration for Multi-USIM purposes; and/or an indication of triggering such provision an indication of preference to reduce UE capabilities for multiple SIMs purposes in MR-DC, when the UE is simultaneously in RRC_CONNECTED mode with multiple networks.

Action 304. The network node receives from the UE 102, the assistance information, wherein the assistance information is related to the MCG, and/or the SCG; and the assistance information is indicating the preference for reduced UE configuration for Multi-SIMs purposes. The network node may receive an indication of preference to reduce UE capabilities for multiple SIMs purposes in MR-DC, when the UE is simultaneously in RRC_CONNECTED with multiple networks. The assistance information may comprise one or more of the following:
an indication of UE preference to have one or more serving cells activated;
an indication of UE preference to one or more serving cells deactivated;
an indication of a reduced configuration that the SCG is allowed to configure;
an indication of preferred UE power class as part of the reduced UE configuration to enable the UE to perform the Multi-SIMs operation.
an indication of UE preference of preferred maximum uplink duty cycle as part of the reduced UE configuration to enable the UE to perform the Multi-SIMs operation.
an indication indicating that the UE can perform the Multi-SIMs operation while still being configured with MR-DC provided that the SCG is deactivated.

Action 306. The network node may then transmit to (or exchange with) another network node, an indication related to the received assistance information. The indication may comprise real text or an index indicating the received assistance information.

Action 308. The network node may further determine whether to initiate reduction of UE configuration taking the received assistance information and/or exchanged indication into account.

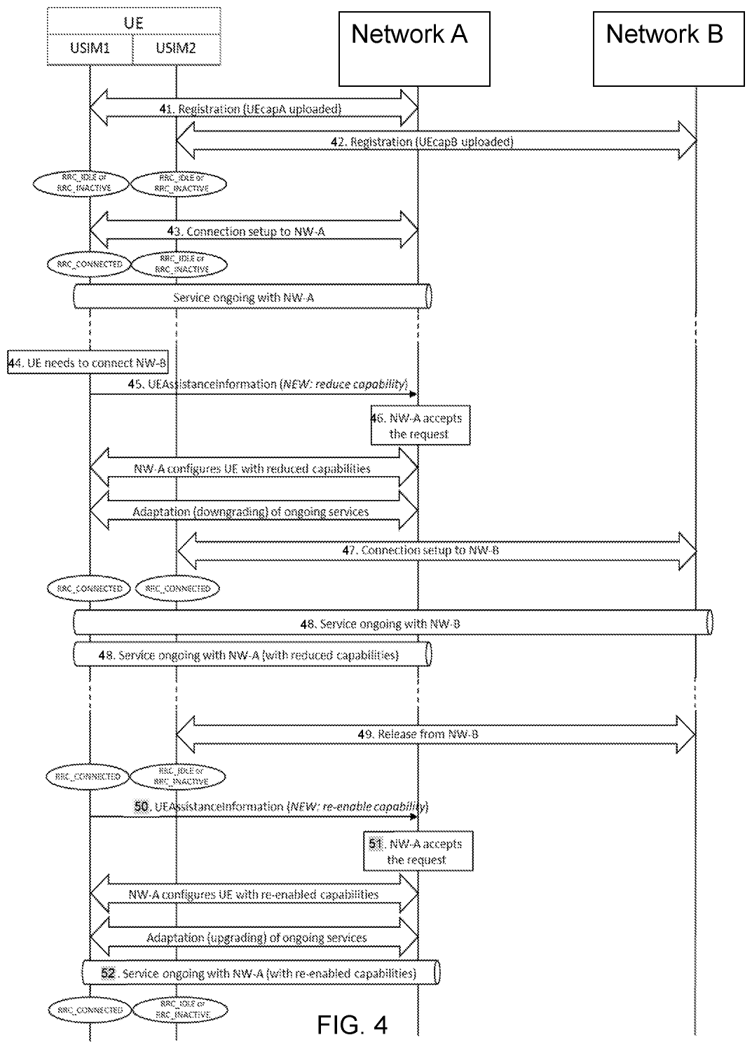

FIG. 4 illustrates a signalling scheme showing communications between a UE 102 and first and second network nodes, in accordance with some embodiments. For illustration purposes only, first and second network nodes, e.g., first and second network nodes 104 and 106, are associated with network A and network B, respectively, and the method is described with reference to networks A and B. In the example illustrated, network A and network B may be referred to as two networks where a Multi-USIM UE is simultaneously in RRC_CONNECTED. It should be appreciated however that the communications as shown in FIG. 4, and as described elsewhere herein, are also applicable to a case where the UE is connected to more than two networks. A person skilled in the art will appreciate how the methods in accordance with embodiments of the present disclosure may be performed in scenarios with more than two networks.

As shown in FIG. 4, the UE, such as the UE 102, may have multiple USIMs. In some embodiments, the different USIMs are associated with different networks, where a network may be a PLMN or an NPN. Furthermore, in some embodiments, a UE has more than one USIM which is associated with the same network, e.g. a UE has two SIMs from the same operator. In the example of FIG. 4, multiple SIMs, such as USIM1 and USIM2 are associated with different networks, but the methods in accordance with embodiments of the present disclosure may also be applied to implementations where multiple USIMs are associated with the same network.

The numbered actions shown in FIG. 4 are described below:

### High-Level Procedure

41. UE registers to Network A
   a. UE uploads UE capabilities relevant for Network A (UEcapA) to Network A
   b. Network A configures UE according to the provided UE capabilities
42. UE registers to Network B
   a. UE upload UE capabilities relevant for Network B (UEcapB) to Network B
   b. Network B configures UE according to the provided UE capabilities
The UE is registered in the two networks and the relevant UE capabilities have been provided.
43. UE starts service(s) in Network A
   a. The UE is in RRC_CONNECTED mode only in Network A (and it is in RRC_IDLE/RRC_INACTIVE state in Network B)
Some time passes . . .
44. UE needs to connect to Network B
45. UE sends UAI to Network A requesting that certain capabilities are (temporarily) disabled
46. Network A accepts the request and disables (possibly temporarily) certain capabilities
   a. Network A can use RRC Reconfiguration procedure or lower layer means, e.g., Medium Access Control (MAC) Control Element (CE) and/or Downlink Control Information (DCI) indication, to configure the UE with reduced capabilities.
   b. Network A or the UE may trigger adaptation (downgrading) for ongoing services in Network A
47. UE uses certain capabilities to connect to Network B
   a. The UE now is in RRC_CONNECTED mode in both networks
48. Service(s) between UE and Network A continue with reduced capabilities
Some time passes . . .
49. Services between UE and Network B are ended, and UE disconnects from Network B
   a. The UE is now in RRC_CONNECTED mode in Network A and in RRC_IDLE (or RRC_INACTIVE) in Network B
50. UE may send UAI to Network A requesting that the certain capabilities are re-enabled
   a. The UE is RRC_INACTIVE in network B and may remain in the current configuration for short resume period before triggering UAI to network A.
      i. This time period can be configurable by either network A or network B.
      ii. This time period can be set the same value as t380 timer configured by network B.
51. Network A may accept the UE request and re-enables the previously disabled capabilities or may re-enable just a sub-set of those capabilities.
   a. Network A can use RRC Reconfiguration or lower layer means (e.g. MAC CE and/or DCI indication) to reconfigure the UE with re-enabled capabilities
   b. Network A or the UE may trigger adaptation (upgrade) for ongoing services in Network A
52. UE and Network A continue using full capabilities
   The high-level procedure is depicted in FIG. 4.

The procedure above describes the case when the UE stays in RRC_CONNECTED mode in Network A the entire time and connect to Network B for a short time. It should be obvious that the same procedure applies in the case that the UE starts in RRC_CONNECTED mode in Network B and then connects to Network A. It should also be obvious that the same procedure applies for a UE that is in RRC_CONNECTED mode in both networks and then leave Network A instead of leaving Network B.

### Triggering Optimizations.

In principle, triggering RRC reconfigurations can be enabled in a more dynamic manner, the RRC message can be sent in advance, but needs to be activated by lower layers, e.g., by a MAC CE, defined in TS 38.213 v. 17.0.0, or DCI and/or uplink control information (UCI), defined in TS 38.212, v. 17.0.0, i.e., the UAI is only applicable when indicated so by lower layers.

For the MAC CE option, at least one new MAC CE, e.g., Multi USIM assistance information (AI) activation/deactivation MAC CE is introduced for the uplink in 3GPP TS 38.321. This also requires a definition of a corresponding Logical Channel Identifier (LCID).
Aᵢ: If there is a Multi USIM assistance information configured for the MAC entity with. AI-Index i as specified in the RRC message. this field indicates the activation/deactivation status of the assistance information element with. AI i. else the MAC entity shall ignore the Aᵢ field. The Aᵢ field is set to 1 to indicate that the. Assistance information element with AI-Index i shall be activated. The Aᵢ field is set to 0 to indicate that the. Assistance information element with AI-Index i shall be deactivated:
R: Reserved bit, set to 0.

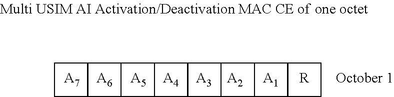

It should be appreciated that values other than 0 and 1 may be used in some embodiments.

Thus, in some embodiments, e.g., in action (45) of FIG. 4, the UAI related to reduced capabilities for Multi USIM may be sent by the UE in advance. The network may thus store the information, but does not consider the information to be valid yet. The request, such as the first or second request, is activated when the UE sends the Multi USIM AI MAC CE or an indication in UCI. In some embodiments, this may be a single bit or even a bitmap.

In some embodiments, the UE may provide, in the UAI, AffectedCarrierFreqList and/or AffectedCarrierFreqCombList. In an example, the UE indicates carriers f2, f3, f4, and f5 as “potentially” affected carriers for network A. The configuration contains 4 entries. A corresponding field is also defined for MAC CE or UCI, i.e., 4 bits would be reserved to indicate those carriers, so the first bit corresponds to f2, the second bit corresponds to f3, and so on. Thus, if some services in network B require the use of f4, a MAC CE or UCI would be sent to network A, where the 3rd bit corresponding to carrier f4 is set to 1. And network A thus knows that it should not configure f4.

Similarly, in some embodiments, the network may in a first step send an RRC reconfiguration for full capabilities and some parts may be subject to upgraded/downgraded UE configuration and are indicated as such, e.g., configuration for carriers f2, f3, f4, and f5 or MIMO layers. The configurations are further provided with an indication whether these should be immediately applied or not. If the configuration should not be immediately applied, the UE only stores the information and waits for lower layer indications to apply the RRC reconfiguration, where the configurations for f2, f3, f4, and f5 are then applied.

When the network A receives the UAI from the UE that f4 is an affected carrier, plus the lower layer trigger, network A sends a MAC CE or DCI with the 3rd bit corresponding to f4 set to 1, such that the UE would deconfigure and no longer use the carrier.

In some embodiments in which a DCI indication is used, a new may be introduced to refer to the indexes in the Multi USIM related RRC Reconfiguration message.

A new MAC CE or DCI where the 3rd bit is set back to 0 means that the UE can revert the deconfiguration, i.e., it uses the upgraded RRC configuration as before.

The UAI with lower layer triggers to activate is simple to apply. The RRC reconfiguration with activation trigger may require more memory in the UE as the UE potentially has to store different versions of the RRC reconfiguration for the downgrade and upgrade, which may thus increase the UE complexity.

Further description of some of UE aspects is provided below, in accordance with embodiments of the present disclosure.

### Description of Some UE Aspects:

The UE aspects in accordance with embodiments of the present disclosure focus on triggering aspects for the UE indication. Example content of such indication and other related aspects are described below.

The UE 102, for example, in MR-DC, may be configured with dual connectivity and to provide UAI to the network concerning a preference for reduced UE configuration for Multi-USIM purposes by any of the following:
a. The UE 102 can be configured to provide assistance information for the MN, related to the MCG configuration, and the UE 102 can be configured to provide assistance information for the SN, related to the SCG configuration;
   In this way, MN and SN can configure the UE independently for the report of assistance information, i.e. the UE 102 is configured to report assistance information to the cell group that configure the UE 102 to provide such assistance information.
b. The UE 102 can be configured to provide assistance information for the MN, related to both the MCG and SCG configuration;
   This option may also be adopted in case the SCG is released to indicate to the MN that the UE 102 has no longer preference on restricting the SCG configuration. For instance, the UE 102 may be configured according to ‘a’ above, and indicate to the SN that it prefers to restrict the SCG configuration; as a result of such indication
      the network may release the SCG configuration. In this case, the UE 102 would have no means to inform the SN that a restriction to the SCG is no longer applicable. Hence, the UE 102 could send such information to the MN, which may then configure the UE 102 with an SCG.
      the network may deactivate the SCG configuration. In this case, the UE 102 keeps the configuration only for certain period e.g., it can be configured by the associated network with a restriction for disabling the SCG configuration.
c. The UE 102 may be configured to provide assistance information for the SN, related to both the MCG and SCG configuration;
d. The UE 102 may be configured to provide assistance information for the MN, related to the MCG configuration, and the UE can be configured to provide assistance information for the SN, related to the MCG configuration;
   The configuration of such assistance information for MCG may be controlled by the MN or both MN and SN. The MN can configure the UE 102 to provide assistance information for the MCG, while in addition: a new field can be included in the MCG configuration to indicate to the UE 102 that it should provide assistance information related to the MCG for the SN as well; or the SN can directly configure the UE 102 to provide assistance information related to the MCG for the SN; or the SN can directly configure the UE to provide SN assistance information related via SRB3.
e. The UE 102 may be configured to provide assistance information for the MN, related to the SCG configuration, and the UE 102 may be configured to provide assistance information for the SN, related to the SCG configuration;
   The configuration of such assistance information for SCG may be controlled by the SN or both MN and SN. The SN can configure the UE 102 to provide assistance information for the SCG, while in addition: a new field can be included in the SCG configuration to indicate to the UE 102 that the UE 102 should provide assistance information related to the SCG for the MN as well; or the MN may directly configure the UE 102 to provide assistance information related to the SCG for the MN.
   This option may also be adopted in case the SCG is released to indicate to the MN that the UE 102 has no longer preference on restricting the SCG configuration. For instance, the UE 102 may be configured according to ‘a’ above, and indicate to the SN that the UE 102 prefers to restrict the SCG configuration; as a result of such indication, the network may release the SCG configuration. In this case, the UE 102 would have no means to inform the SN that a restriction to the SCG is no longer applicable. Hence, the UE 102 could send such information to the MN, which may then configure the UE 102 with an SCG.
f. The UE 102 may be configured with specific parameters that the UE 102 is allowed to report differently for MCG and SCG.
Any of the UE configuration methods above where the configuration is provided via an RRC message:
   The RRC message may be defined as RRCReconfiguration
   The configuration maybe be contained in the information element (IE) OtherConfig, which contains configuration related to miscellaneous other configurations.

The UE 102, for example, in MR-DC, may be configured with dual connectivity using a primary cell (PCell) and a secondary cell (SCell) such as a primary secondary cell (PSCell), and to provide UAI to the network concerning a preference for reduced UE configuration for Multi-USIM purposes. Such assistance information may comprise any of the following:
a. Indication of UE preference to have one or more serving cells activated.
   i. This can be further used to change previous UEs preferences, e.g., if previously the UE 102 indicated that it would prefer to have a serving cell deactivated, it can send another message in future indicating preference to have an SCell activated.
   ii. The UE 102 determines that it wants to activate a serving cell, for example, based on early indications in the UE 102, e.g., that a certain app is started or that certain measurements are to be sent, based on UE mobility or based on traffic conditions, data volume calculation, type of traffic requiring of serving cell to be active.
b. Indication of UE preference to one or more serving cells deactivated.
   i. Alternatively, the UE 102 may indicate a preference to not keep the SCell activated. The main difference in this case is that the network does not interpret the UE report as meaning necessarily that the UE 102 would prefer the SCell to be deactivated. On the contrary, this would rather mean that the SCell activated state is not preferred-that implies that the UE 102 may not have a particular preference on whether the SCell is deactivated, released or reconfigured.
c. Indication of the reduced configuration that the SCG is allowed to configure.
   i. The UE 102 may indicate to release the SCG, e.g. by setting a proper bit, or indicate the reduced bandwidth (BW) for frequency range 1 (FR1), for frequency range 2 (FR2), i.e., maximum aggregated bandwidth across all downlink and uplink carriers, or the reduced component carriers (CC) for FR1 for FR2, i.e., maximum number of downlink/uplink PSCell/SCells that the SCG is allowed to configure
d. In another example, the indication of UE preference may include recommended/preferred UE power class(es) as part of the reduced UE configuration/capability to enable the UE to perform the multi-USIM operation. The UE recommendation enables dynamic or semi-static modification of its power class. The UE power class defines the maximum output power supported by the UE 102 for transmitting signals when operating on certain band or band combination. Examples of UE power classes are power class 1 (e.g. 31 dBm), power class 1.5 (e.g. 29 dBm), power class 2 (e.g. 26 dBm), power class 3 (e.g. 23 dBm), power class 5 (e.g. 20 dBm), etc. For example, assume that the UE 102 supports and is capable of MR-DC operation using UE power class 1.5 (e.g. 29 dBm) for certain MR-DC band combination/configuration. The UE 102 may indicate that for multi-USIM operation the UE prefers to operate using only MCG, i.e. without MR-DC, in network A and using UE power class 3. The UE 102 may further indicate that for multi-SIM operation the UE prefers to operate using only MCG, i.e., without MR-DC, in network B and also using UE power class 3. In another example, the UE 102 may further indicate that for multi-SIM operation the UE prefers to operate using only MCG, i.e., without MR-DC, in network A and network B using UE power class 5 in each of the 2 networks. Since network A and network B do not coordinate, therefore restriction in UE power class may enable the UE 102 to meet regulatory requirements related to radiation exposure to humans e.g. electromagnetic power density exposure requirements provided by regulatory bodies such as Specific absorption rate (SAR).
e. In another example, the indication of UE preference may include recommended/preferred maximum uplink duty cycle (MUDC) as part of the reduced UE configuration/capability to enable the UE 102 to perform the multi-USIM operation. The MUDC indicates the maximum percentage of time resources, e.g. symbols, slots, subframes, during a certain evaluation period, e.g. T1 seconds such as 1 second, that can be scheduled for uplink transmission to ensure that the UE 102 meets the exposure requirements, e.g. electromagnetic energy absorption requirements such as SAR, specified by regulatory bodies. The UE 102 may further indicate the preferred UE power class for Multi-SIMs operation in one or more networks. For example, for MR-DC operation the UE 102 may support certain MUDC, e.g. X1 percentage. However, for Multi-SIMs operation, the UE 102 may indicate to the network node in the assistance information to adapt the MUDC to another value, e.g., X2 percentage. In one example, X2<X1. In another example, X1=80% while X2=50%. Therefore, for example, a network node, e.g., the SN, may configure the UE 102 in network A with only MCG, e.g. without MR-DC, and schedule the UE 102 in the uplink in network A using MUDC with value not exceeding X2%. The UE 102 may recommend the same or different MUDC value for multi-USIM operation in network B. Thanks to the reduced capability/configuration of the MUDC in the Multi-SIMs operational scenario, in one example the UE 102 may be able to use the same UE power class as it uses while configured in MR-DC. In another example the UE 102 may recommend to use the lower UE power class then it can use while configured in MR-DC e.g. 23 dBm in each network in multi-SIM, while 26 or 29 dBm when configured with MR-DC.
f. In another example, the UE 102 may indicate that the UE 102 can perform the multi-USIM operation while still being configured with MR-DC, e.g. in network A, provided that the SCG is deactivated. On the other hand in network B, the UE 102 may operate without MR-DC i.e. using only MCG. The UE 102 may further indicate that the UE 102 can perform the multi-USIM operation while still being configured with MR-DC provided that the SCG, e.g. in network A, is deactivated for at least certain time period, e.g., a T2 period. In one example, the Multi-SIMs operation is realized in best effort manner, e.g., whenever the SCG in network A is deactivated. In other words, the Multi-SIMs operation in network B is done opportunistically. The UE 102 may further inform the serving cell, e.g. the PCell, in network B that it can operate or it is going to operate in network B over limited time period and/or in opportunistic or best effort manner. The serving cell, e.g. the PCell, in network B may further inform or configure the UE 102 with a minimum time duration and/or maximum time duration over which the UE operation in network B can be performed in opportunistic manner e.g. by sending a message to the UE 102. The serving cell, e.g. the PCell, in network B may also accept or reject the UE operation in network B in best effort manner e.g. by sending a message to the UE 102. In another example, the network node, e.g. the SN, in network A, based on the UE request, may deactivate the SCG or deactivates the SCG for at least T2. This enables the UE 102 to perform the Multi-SIMs operation. The UE 102 may further inform network node, e.g., the SN, in network B, that the UE 102 can operate in network B only in RRC connected state over certain time period, e.g., over period T2, starting from a reference time, e.g. current time, system frame number (SFN) number K1 etc. T2 can be expressed in terms of time duration, e.g., T21 seconds, or in terms of certain number of time resources, e.g., N1 number of frames, N2 number of SFN cycles, N3 number of hyper SFN cycles etc. To operate in network B, while the SCG in network A is deactivated, the UE 102 may retune its transceiver on at least one carrier frequency, e.g., of PCell, used in network B. However, the UE 102 may also occasionally and periodically, e.g. once every 1280 ms, retune the transceiver for short time, e.g. 1-5 ms, on at least one carrier frequency, e.g. of PSCell, used in SCG in network A for performing measurements e.g. reference signal received power (RSRP), reference signal received quality (RSRQ), radio link monitoring, link recovery procedure such as beam failure detection, candidate beam detection, L1-RSRP etc. The periodical retuning to the carrier of SCG, in network A, may cause interruption of signals in network B e.g. the UE 102 does not receive or transmit signals in network B during the interruption duration. The SCG of the UE 102 can be activated or deactivated by the network node, e.g., PCell, by sending a command or message, e.g., RRC, MAC CE, DCI etc, to the UE 102. The deactivation of SCG deactivates all the serving cells in the SCG, e.g., PSCell, SCell etc. The UE 102 is scheduled with data, e.g. physical downlink shared channel (PDSCH), physical uplink shared channel (PUSCH) etc, only when the serving cell is activated. The deactivation of the SCG enables the UE 102 to save and conserve its battery power. The network node may use one or more criteria to deactivate the SCG such as when the UE 102 does not have enough data, e.g., buffer size is below a threshold value etc, if the UE battery power is below threshold, base station cannot schedule the UE 102 due to high load/lack of resources etc.

The UE 102, for example, in MR-DC, can be configured to provide UAI to the network concerning a preference for reduced UE configuration for Multi-SIM purposes. Such assistance information and/or activation requests may be triggered, or prevented to be triggered, by any of following:
1. Change of UE conditions on each network it is connected. Depending on different aspects related to each network the UE 102 is connected, it may decide to trigger a UAI report or trigger to send an activation request for one or more elements provided in the UAI, those different aspects include any of:
   a. Channel conditions in at least one of the networks the UE 102 is connected. For instance, the channel conditions for Network A may have become worse while they were improved for Network B, hence the UE 102 could report to Network A a preference for reduced configuration while it could report for Network B a preference for a “better” configuration, higher bandwidth, more component carriers, etc.
   b. Change of data demands in at least one of the networks the UE is connected. For instance, while there is low data demand for Network A, the UE could report to Network A a preference for reduced configuration while it could report for Network B a preference for a “better” configuration (higher bandwidth, more component carriers, etc.).
2. A timer to prohibit frequent reports sent by the UE 102, i.e., the UE 102 can only send another report or trigger once the timer expires.
3. Providing different information as a condition to send a subsequent report, i.e. if the UE 102 have already sent a report concerning reduced UE configuration for Multi-USIM purposes, it can only send another report if it concerns different information compared to the previous report.
4. Report based on cause value, i.e. the UE 102 can only send a report concerning reduced UE configuration for Multi-USIM purposes if the report is triggered by specific cause e.g. low battery, traffic level.
5. Network configured conditions, which could include any of the other conditions listed here.
6. During a handover to a target cell, right after the handover, or during reconfiguration with sync, the UE 102 may indicate the preference of reduced UE configuration for Multi-USIM purposes to the target cell.
7. During a reconfiguration procedure other than handover.
8. During a connection setup e.g. after security is established.
9. During a re-establishment procedure.
10. During a resume procedure.
11. Before the UE 102 is suspended, i.e. moved to RRC_INACTIVE.
12. For the UE 102 that is configured to provide assistance information on reduced UE configuration/capabilities for Multi-SIMs purposes, when the UE initiates RRC connection re-establishment procedure or when the UE initiates a RRC resume procedure, the configuration related with assistance information on reduced UE configuration for Multi-USIM purposes is released by the UE 102.
13. If sending a UE assistance information message that does no longer include an indication of UE preference for a certain reduced UE configuration/capabilities for Multi-USIM purposes. As an example, if the UE 102 has sent a UAI to the network with an indication of UE preference to have reduced MIMO layers, the transmission of a new UAI message where this indication, of UE preference to have reduced MIMO layers, is not present corresponds to no longer having a preference on reduced MIMO layers.

### Description of Network Aspects:

This section focuses on network actions that may be executed before and after the reception of the UE indications.
A network node, such as the first network node 104 or the second network node 106 may configure the UE 102 to provide UAI to the network concerning reduced UE configuration for Multi-SIM purposes. The network node may decide to configure the UE 102 to provide such information based on the awareness that the UE is a Multi-SIM UE.
The MN (e.g. PCell) and SN (e.g. PSCell) may exchange information about the restricted/reduced UE capability or configuration received from the UE 102, e.g., by using CG-ConfigInfo/CG-Config containers or Xn/X2 interfaces. For example, if the information is received by the MN then it may transmit it to SN. On the other hand, if the information is received by the SN then it may transmits it to MN. The MN and SN may further communicate with each other to determine whether to continue the UE operation, e.g. in network A, but with reduced UE capability/configuration or not. The MN and SN may further exchange information to determine the timing when the operation, e.g. in network A, will start with reduced UE capability/configuration. The MN and SN may further communicate with each other to determine whether to revert to the UE operation, e.g., in network A, with full UE capability or configuration or not e.g. whether to re-enable the UE 102 with full or original UE capability or configuration. The MN and SN may further exchange information to determine the timing when the operation, e.g., in network A, will start with full or original UE capability/configuration. The information exchanged between MN and SN may comprise any of the information related to the UE indication sent to the network described in the UE embodiments above.
For example at reception of UAI for restricting UE capabilities, the first network node 104 e.g., the PCell network node may indicate to the second network node 106 e.g., the PSCell network node, that while the SCG is deactivated, the UE 102 may perform the Multi-SIMs operation in another network e.g. in network B. The PCell may further indicate to the PSCell, that the SCG is going to be deactivated for certain time period, e.g. until time, T2 starting from reference time, e.g. current time, or time when the SCG is deactivated. During this time the UE 102 may perform the Multi-SIMs operation in another network, e.g. in network B, in opportunistic manner. The SCG may be activated with a UE indication e.g., with reception of UAI for enabling the restricted capabilities.

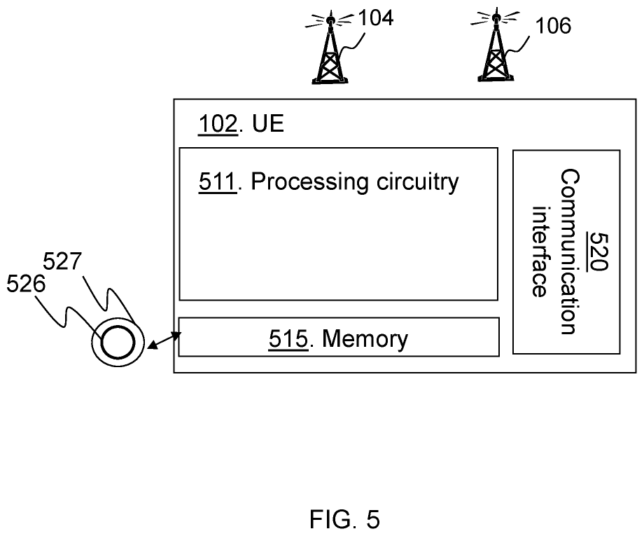

FIG. 5 depicts an example of a UE, such as the UE 102, having at least two SIM for simultaneous communication with two or more networks in accordance with embodiments herein. The UE 102 may have at least a first SIM and a second SIM.

The UE 102 may comprise processing circuitry 511, e.g. one or more processors, configured to perform the methods herein.

The UE 102 and/or the processing circuitry 511 is configured to provide assistance information to the network node, wherein the assistance information is related to MCG and/or SCG; and the assistance information is indicating the preference for reduced UE configuration for Multi-SIMs purposes.

The UE 102 and/or the processing circuitry 511 may be configured to transmit the assistance information to the network node in response to one or more out of:
availability of information to be sent in the first request that is different from information previously sent in a prior request to the first network node 104 concerning a reduced set of capabilities;
an occurrence of an event;
an occurrence of one or more network configured conditions;
a handover of the UE (102) from a source cell to a target cell;
a reconfiguration procedure other than a handover;
a connection setup;
a re-establishment procedure;
a resume procedure;
before the UE is moved to RRC_INACTIVE;
for a UE that is configured to provide assistance information on reduced UE configuration/capabilities for Multi-SIMs purposes, when the UE initiates RRC connection re-establishment procedure or when the UE initiates a RRC resume procedure, the configuration related with assistance information on reduced UE configuration for Multi-SIMs purposes is released by the UE; and
if sending a UE assistance information message to another network node that does no longer include an indication of UE preference for a certain reduced UE configuration/capabilities for Multi-SIMs purposes.

The UE 102 and/or the processing circuitry 511 may be configured to configure the UE 102 to provide the assistance information, and/or with one or more triggering conditions. For example, the UE 102 and/or the processing circuitry 511 may be configured to configure the UE 102 to provide the assistance information, and/or with one or more triggering conditions by configuring the UE 102 to provide the assistance information related to MCG and/or SCG; and assistance information indicating a preference for reduced UE configuration for Multi-SIMs purposes; and/or an indication of triggering such provision of an indication of preference to reduce UE capabilities for Multiple SIMs purposes in MR-DC, when the UE is simultaneously in RRC_CONNECTED mode with multiple networks.

The UE 102 and/or the processing circuitry 511 may be configured to check the condition to trigger sending the assistance information to the network node.

The condition may define a change in a channel condition and/or a change of data demands.

The assistance information may comprise one or more of the following:
an indication of UE preference to have one or more serving cells activated;
an indication of UE preference to one or more serving cells deactivated;
an indication of a reduced configuration that the SCG is allowed to configure;
an indication of preferred UE power class as part of the reduced UE configuration to enable the UE to perform the Multi-SIMs operation.
an indication of UE preference of preferred maximum uplink duty cycle as part of the reduced UE configuration to enable the UE to perform the Multi-SIMs operation.
an indication indicating that the UE can perform the Multi-SIMs operation while still being configured with MR-DC, provided that the SCG is deactivated.

The UE 102 and/or the processing circuitry 511 may be configured to be configure the UE to provide the assistance information, and/or with one or more conditions (triggering conditions).

The UE 102 and/or the processing circuitry 511 may be configured to check a condition to trigger sending the assistance information to the first wireless communications network 140. The UE 102 and/or the processing circuitry 511 may be configured to be triggered to provide to the first network node 104 the assistance information in response to a change in at least one condition of the UE 102 in at least one of the first and second wireless communications networks 140 and 160, respectively, wherein the change in the at least one condition comprises a channel condition and/or a change of data demands. The at least one condition may comprise a channel condition.

The one or more conditions may comprise a change of data demands in at least one of the first and second wireless communications networks 140 and 160, respectively.

The assistance information may be provided in response to an expiration of a timer.

The UE 102 and/or the processing circuitry 511 may be configured to provide the assistance information to the network node 104/106 in response to one or more out of:
availability of information to be sent in the first request that is different from information previously sent in a prior request to the first network node 104 concerning a reduced set of capabilities;
an occurrence of an event;
an occurrence of network configured conditions;
a handover of the UE 102 from a source cell to a target cell;
a reconfiguration procedure other than a handover;
a connection setup;
a re-establishment procedure;
a resume procedure;
before the UE is suspended, i.e. moved to RRC_INACTIVE;
for a UE that is configured to provide assistance information on reduced UE configuration/capabilities for Multi-SIMs purposes, when the UE initiates RRC connection re-establishment procedure or when the UE initiates a RRC resume procedure, the configuration related with assistance information on reduced UE configuration for Multi-USIM purposes is released by the UE; and
if sending a UE assistance information message to another network node that does no longer include an indication of UE preference for a certain reduced UE configuration/capabilities for Multi-USIM purposes. As an example, if the UE has sent a UE assistance information message to the network with an indication of UE preference to have reduced MIMO layers, the transmission of a new UE assistance information message where this indication (of UE preference to have reduced MIMO layers) is not present corresponds to no longer having a preference on reduced MIMO layers.

The UE 102 and/or the processing circuitry 511 may be configured to provide, e.g., transmit, the assistance information to the network node such as the first network node 104 and/or the second network node 106. Thus, The UE 102 and/or the processing circuitry 511 may be configured to provide the indication of preference or capability to reduce UE capabilities for multiple SIMs purposes in MR-DC, when the UE is simultaneously in RRC_CONNECTED mode with multiple networks. The UE 102 and/or the processing circuitry 511 may be configured to transmit the assistance information when being triggered.

The UE 102 further comprises a memory 515. The memory 515 comprises one or more units to be used to store data on, such as indications, contexts, measurements, thresholds, data related to nodes, and applications to perform the methods disclosed herein when being executed, and similar. Furthermore, the UE 102 may comprise a communication interface 520 such as comprising a transmitter, a receiver and/or a transceiver. The communication interface 520 may comprise dual Rx and Tx radios. In some embodiments, the communication interface 520 comprises more than two radios.

The methods according to the embodiments described herein for the UE 102 are respectively implemented using e.g., a computer program product 526 or a computer program, comprising instructions, i.e., software code portions, which, when executed on at least one processor, cause the at least one processor to carry out the actions described herein, as performed by the UE 102. The computer program product 526 may be stored on a computer-readable storage medium 527, e.g. a disc, a universal serial bus (USB) stick or similar. The computer-readable storage medium 527, having stored thereon the computer program product, may comprise the instructions which, when executed on at least one processor, cause the at least one processor to carry out the actions described herein, as performed by the UE 102. In some embodiments, the computer-readable storage medium may be a transitory or a non-transitory computer-readable storage medium. Thus, embodiments herein may disclose a UE for handling communication in a wireless communications network, wherein the UE comprises processing circuitry and a memory, the memory comprising instructions executable by the processing circuitry whereby the UE is operative to perform any of the methods herein.

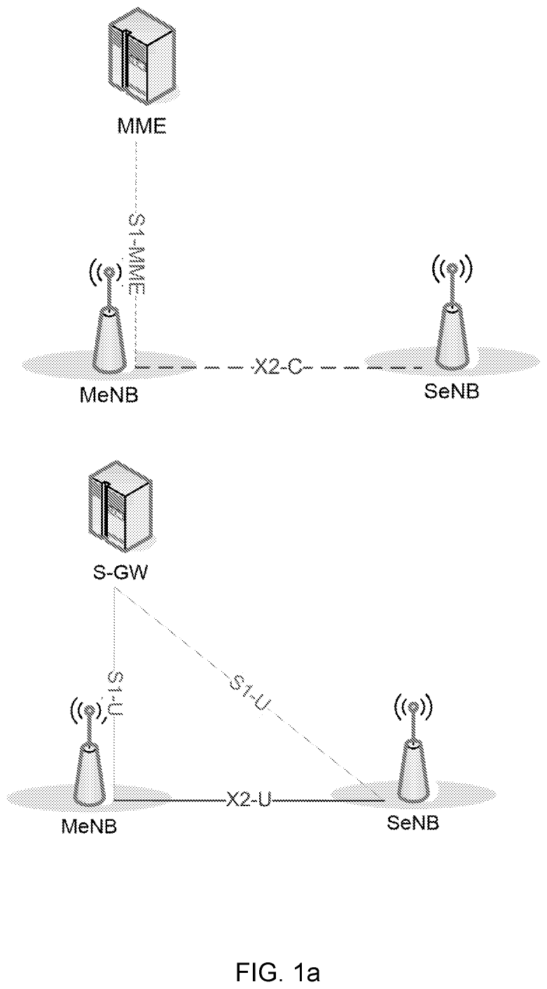

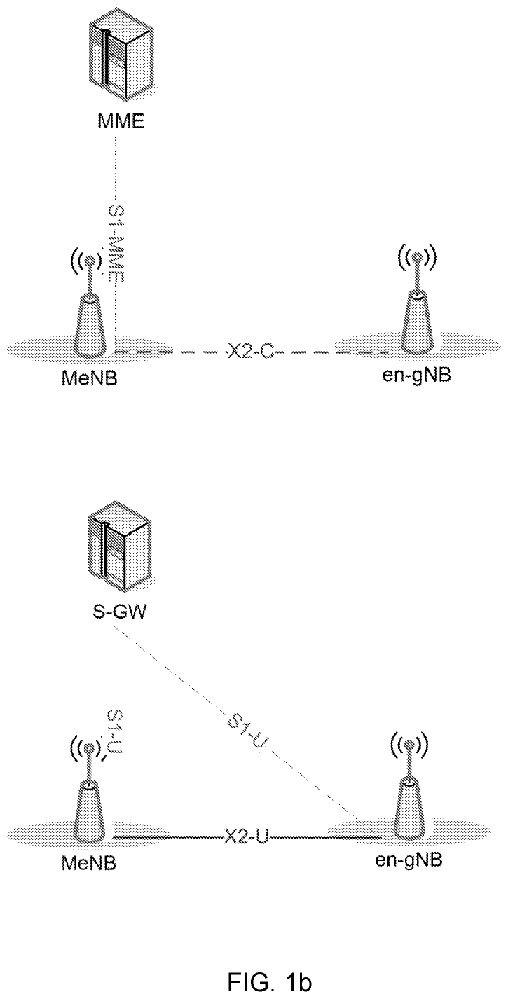

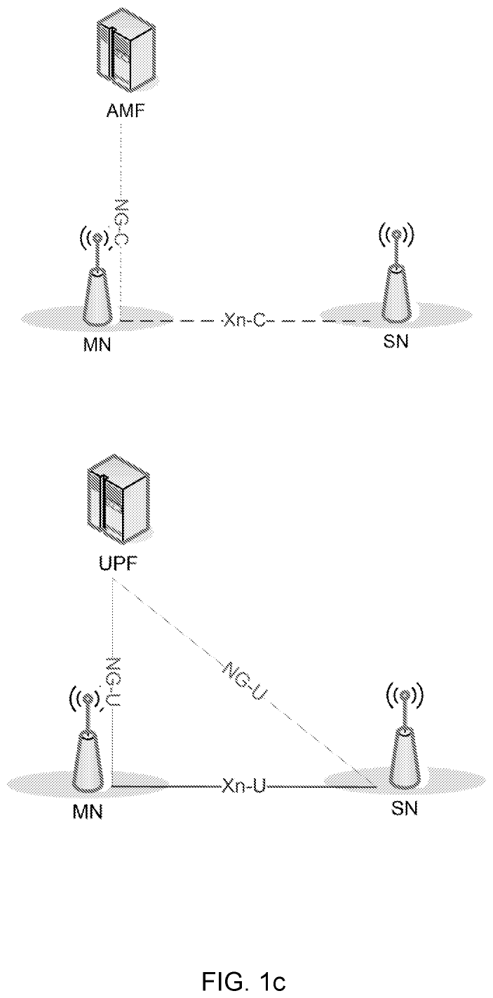

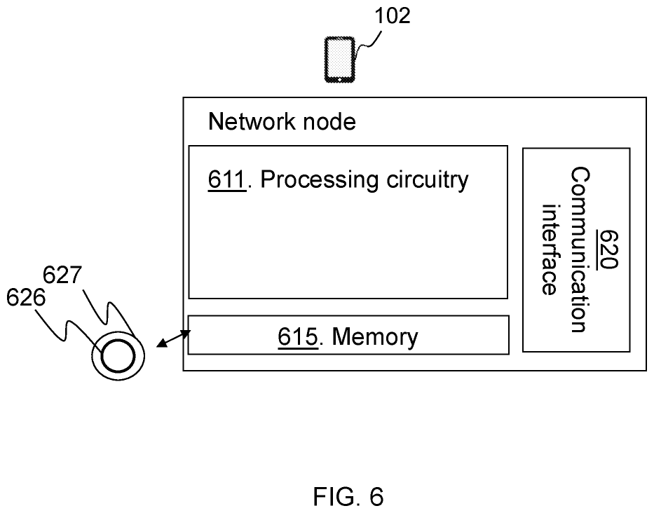

FIG. 6 depicts an example of a network node associated with the wireless communications network, such as the first network node 104 or the second network node 106, in accordance with embodiments herein. It should be appreciated that the first network node 104 and the second network node 106 (see FIG. 1a) may have the same or similar configurations, and are therefore not described separately herein. The network node is associated with the wireless communication network, such as, e.g., the first network 140 and the second network 160, referred to herein as a wireless communication network. The wireless communication network may be associated with one of SIMs of a

UE, such that the UE 102. For example, the wireless communication network may be associated with a first SIM, though it should be appreciated that SIMs are referred to herein as first and second for description purposes only.

The network node may comprise processing circuitry 611, e.g. one or more processors, configured to perform the methods herein.

The network node and/or the processing circuitry is configured to receive assistance information from the UE 102, wherein the assistance information is related to the MCG, and/or the SCG; and the assistance information indicates the preference for reduced UE configuration for Multi-SIMs purposes.

The assistance information may comprise one or more of the following:
an indication of UE preference to have one or more serving cells activated;
an indication of UE preference to one or more serving cells deactivated;
an indication of a reduced configuration that the SCG is allowed to configure;
an indication of preferred UE power class as part of the reduced UE configuration to enable the UE to perform the Multi-SIMs operation.
an indication of UE preference of preferred maximum uplink duty cycle as part of the reduced UE configuration to enable the UE to perform the Multi-SIMs operation.
an indication indicating that the UE can perform the Multi-SIMs operation while still being configured with MR-DC, provided that the SCG is deactivated.

The network node and/or the processing circuitry may be configured to configure the UE to provide the assistance information related to MCG and/or SCG; and assistance information indicating a preference for reduced UE configuration for Multi-SIMs purposes; and/or an indication of triggering such provision of an indication of preference to reduce UE capabilities for Multiple SIMs purposes in MR-DC, when the UE is simultaneously in RRC_CONNECTED with multiple networks.

The network node and/or the processing circuitry may be configured to transmit to another network node, an indication related to the received assistance information.

The network node and/or the processing circuitry may be configured to determine whether to initiate reduction of UE configuration taking the received assistance information and/or an exchanged indication into account.

The network node and/or the processing circuitry 611 may be configured to configure the UE 102 to provide the assistance information related to MCG and/or SCG; and assistance information concerning a preference for reduced UE configuration for Multi-USIM purposes; and/or an indication of triggering such provision an indication of preference to reduce UE capabilities for multiple SIMs purposes in MR-DC, when the UE is simultaneously in RRC_CONNECTED mode with multiple networks.

The network node and/or the processing circuitry 611 is configured to receive from the UE 102, the assistance information. Thus, the network node and/or the processing circuitry 611 may be configured to receive the indication of preference or capability to reduce UE capabilities for multiple SIMs purposes in MR-DC, when the UE is simultaneously in RRC_CONNECTED mode with multiple networks.

The network node and/or the processing circuitry 611 may be configured to transmit to (or exchange with) another network node, an indication related to the received assistance information.

The network node and/or the processing circuitry 611 may be configured to determine whether to initiate reduction of UE configuration taking the received assistance information and/or exchanged indication into account.

The network node comprises a memory 615. The memory 615 comprises one or more units to be used to store data on, such as assistance information, indications, contexts, measurements, thresholds, data related to nodes, and applications to perform the methods disclosed herein when being executed, and similar. Furthermore, the network node may comprise a communication interface 620 such as comprising a transmitter, a receiver, a transceiver, and/or one or more antennas.

The methods according to the embodiments described herein for the network node are respectively implemented using e.g., a computer program product 626 or a computer program, comprising instructions, i.e., software code portions, which, when executed on at least one processor, cause the at least one processor to carry out the actions described herein, as performed by the network node. The computer program product 626 may be stored on a computer-readable storage medium 627, e.g. a disc, a universal serial bus (USB) stick or similar. The computer-readable storage medium 627, having stored thereon the computer program product, may comprise the instructions which, when executed on at least one processor, cause the at least one processor to carry out the actions described herein, as performed by the network node. In some embodiments, the computer-readable storage medium may be a transitory or a non-transitory computer-readable storage medium. Thus, embodiments herein may disclose a network node for handling communication in a wireless communications network, wherein the network node comprises processing circuitry and a memory, the memory comprising instructions executable by the processing circuitry whereby the network node is operative to perform any of the methods herein.

In some embodiments, a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used and it refers to any type of wireless device communicating with a network node and/or with another wireless device in a cellular or mobile communication system. Examples of UE are IoT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Embodiments herein relate to:

### Embodiment A1

A method performed by a user equipment, UE, (102) having at least two Subscriber Identity Modules, SIMs, for simultaneous communication with two or more networks, the method comprising:
providing assistance information to a network node, wherein the assistance information is related to MCG and/or SCG; and assistance information indicating a preference for reduced UE configuration for Multi-SIMs purposes.

### Embodiment A2

The method according to embodiment A1, wherein the UE transmits the assistance information to the network node in response to one or more out of:
availability of information to be sent in the first request that is different from information previously sent in a prior request to the first network node 104 concerning a reduced set of capabilities;
an occurrence of an event;
an occurrence of network configured conditions;
a handover of the UE 102 from a source cell to a target cell;
a reconfiguration procedure other than a handover;
a connection setup;
a re-establishment procedure;
a resume procedure;
before the UE is suspended, i.e. moved to RRC_INACTIVE;
for a UE that is configured to provide assistance information on reduced UE configuration/capabilities for Multi-SIMs purposes, when the UE initiates RRC connection re-establishment procedure or when the UE initiates a RRC resume procedure, the configuration related with assistance information on reduced UE configuration for Multi-USIM purposes is released by the UE; and
if sending a UE assistance information message that does no longer include an indication of UE preference for a certain reduced UE configuration/capabilities for Multi-USIM purposes. As an example, if the UE has sent a UE assistance information message to the network with an indication of UE preference to have reduced MIMO layers, the transmission of a new UE assistance information message where this indication (of UE preference to have reduced MIMO layers) is not present corresponds to no longer having a preference on reduced MIMO layers.

### Embodiment A3

The method according to any of the embodiments A1 or A2, further comprising:
being configured to provide the assistance information, and/or with one or more triggering conditions.

### Embodiment A4

The method according to any of the embodiments A1, A2 or A3, further comprising:
checking a condition to trigger sending the assistance information to the first wireless communications network.

### Embodiment B1

A method performed by a network node associated with a wireless communications network, the method comprising:
receiving assistance information from a UE, wherein the assistance information is related to MCG and/or SCG; and assistance information indicating a preference for reduced UE configuration for Multi-SIMs purposes.

### Embodiment B2

The method according to embodiment B1, comprising:
configuring the UE to provide the assistance information related to MCG and/or SCG; and assistance information indicating a preference for reduced UE configuration for Multi-USIM purposes; and/or an indication of triggering such provision of an indication of preference to reduce UE capabilities for Multiple SIMs purposes in MR-DC, when the UE is simultaneously in RRC_CONNECTED mode with multiple networks.

### Embodiment B3

The method according to any of the embodiments B1-B2, comprising:
transmitting to another network node, an indication related to the received assistance information.

### Embodiment B4

The method according to any of the embodiments B1-B3, comprising:
determining whether to initiate reduction of UE configuration taking the received assistance information and/or exchanged indication into account.

### Embodiment C1

A computer program product comprising instructions, which, when executed on at least one processor, cause the at least one processor to carry out the methods above, as performed by the UE and the network node, respectively.

### Embodiment C2

A computer-readable storage medium, having stored thereon a computer program product comprising instructions which, when executed on at least one processor, cause the at least one processor to carry out the methods above, as performed by the UE and the network node, respectively.

### Embodiment D1

A user equipment, UE, (102) having at least two Subscriber Identity Modules, SIMs, for simultaneous communication with two or more networks, wherein the UE is configured to
provide assistance information to a network node, wherein the assistance information is related to MCG and/or SCG; and assistance information indicating a preference for reduced UE configuration for Multi-SIMs purposes.

### Embodiment D2

A network node associated with a wireless communications network, wherein the network node is configured to
receive assistance information from a UE, wherein the assistance information is related to MCG and/or SCG; and assistance information indicating a preference for reduced UE configuration for Multi-SIMs purposes.

The present disclosure further comprises embodiments, and any combination of the embodiments, according to any one or more of embodiments herein.

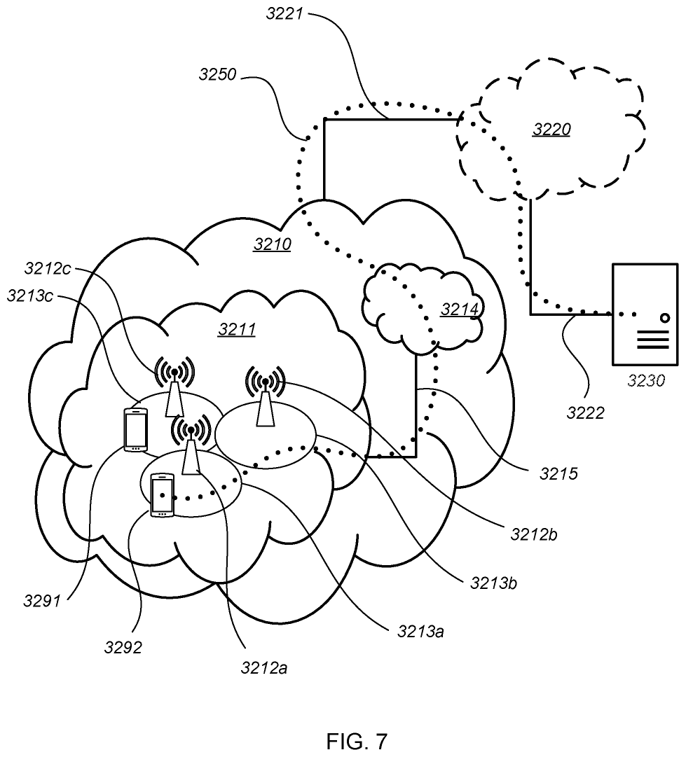

FIG. 7 shows a telecommunication network connected via an intermediate network to a host computer in accordance with some embodiments. With reference to FIG. 7, in accordance with an embodiment, a communication system includes a telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 7 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

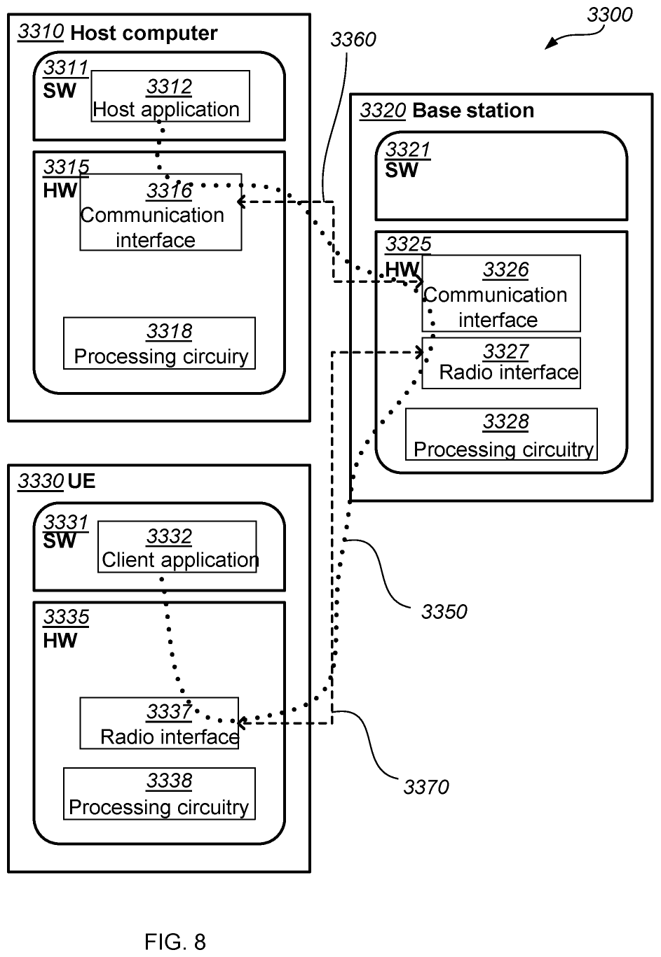

FIG. 8 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 8. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 8) served by base station 3320. Communication interface 3326 may be configured to facilitate connection 3360 to host computer 3310. Connection 3360 may be direct or it may pass through a core network (not shown in FIG. 8) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 8 may be similar or identical to host computer 3230, one of base stations 3212a, 3212b, 3212c and one of UEs 3291, 3292 of FIG. 7, respectively. This is to say, the inner workings of these entities may be as shown in FIG. 8 and independently, the surrounding network topology may be that of FIG. 7.

In FIG. 8, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible to communicate simultaneously using at least two SIMs and may improve latency and thereby provide benefits such as reduced user waiting time and extended battery lifetime.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors, etc.

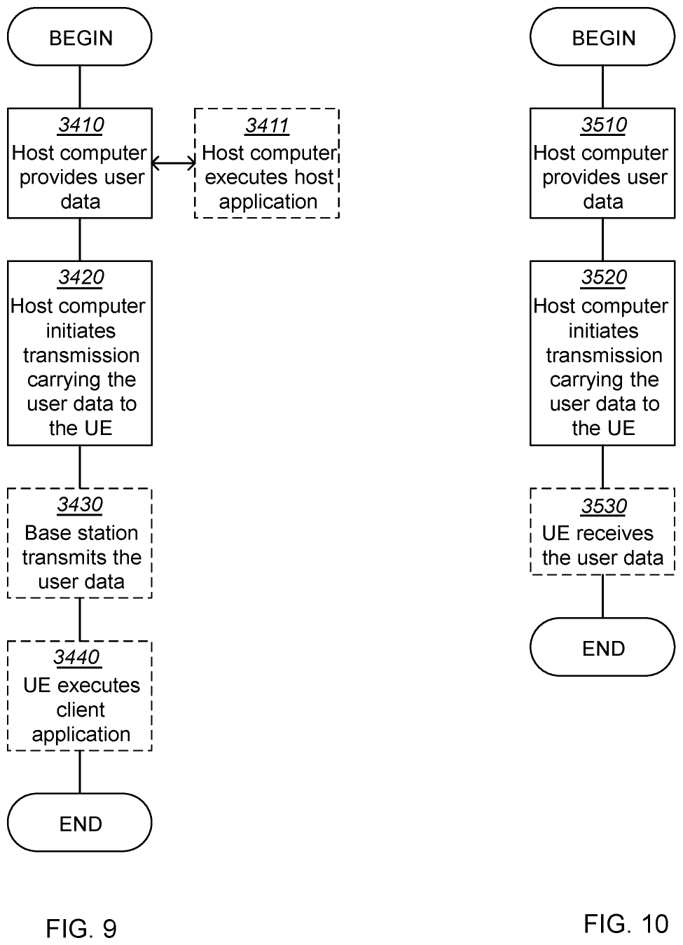

FIG. 9 shows methods implemented in a communication system including a host computer, a base station and a user equipment in accordance with some embodiments.

FIG. 9 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 9 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 10 shows methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

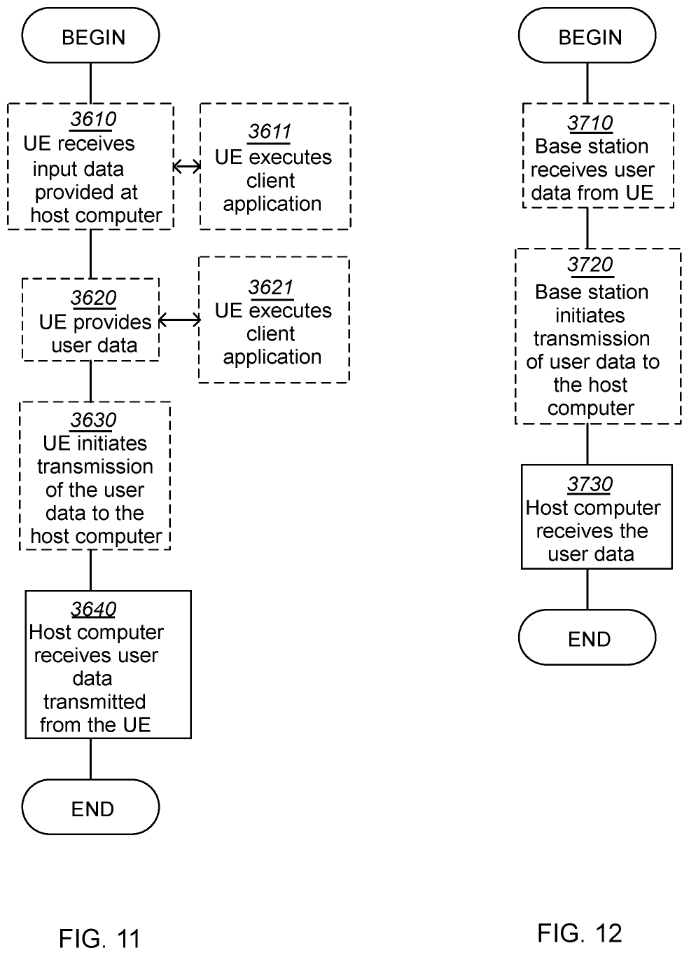

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 12 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein.

As such, the apparatus and techniques taught herein are not limited by the foregoing description and accompanying drawings. Instead, the embodiments herein are limited only by the following claims and their legal equivalents.

### REFERENCES

1. RRP-202895, “Support for Multi-SIM devices for LTE/NR,” 3GPP TSG RAN Meeting #90e. Electronic Meeting, Dec. 7-11, 2020. China Telecom, China Unicom.
2. RP-212015, “Enhanced support for multi-SIM devices in Rel-18,” 3GPP TSG RAN 93e. Electronic Meeting, Sep. 13-17, 2021; source: vivo.

1.-27. (canceled)

28. A method performed by a user equipment (UE) having at least two Subscriber Identity Modules (SIM) for simultaneous communication with two or more networks, the method comprising:
providing assistance information to a network node, wherein the assistance information is related to a master cell group (MCG) and/or a secondary cell group (SCG) and the assistance information indicates a preference for reduced UE configuration for Multi-SIMs purposes.

29. The method according to claim 28, wherein providing the assistance information comprises transmitting the assistance information to the network node in response to one or more of:
availability of information to be sent in a first request that is different from information previously sent in a prior request to the network node concerning a reduced set of capabilities;
an occurrence of an event;
an occurrence of one or more network-configured conditions;
a handover of the UE from a source cell to a target cell;
a reconfiguration procedure other than a handover;
a connection setup;
a re-establishment procedure;
a resume procedure;
before the UE is moved to RRC_INACTIVE;
for a UE that is configured to provide assistance information on reduced UE configuration for Multi-SIMs purposes, when the UE initiates a Radio Resource Control (RRC) connection re-establishment procedure or when the UE initiates a RRC resume procedure, the configuration related with assistance information on reduced UE configuration for Multi-SIM purposes is released by the UE; and
sending, to another network node, a UE assistance information message that no longer includes an indication of UE preference for a certain reduced UE configuration for Multi-SIM purposes.

30. The method according to claim 28, further comprising configuring the UE to provide the assistance information and/or configuring the UE with one or more triggering conditions under which the UE is to provide the assistance information.

31. The method according to claim 30, wherein configuring the UE to provide the assistance information and/or configuring the UE with the one or more triggering conditions comprises configuring the UE to provide the assistance and/or an indication of triggering provision of an indication of a preference to reduce UE capabilities for Multiple SIMs purposes in multi radio access technology (MR)-dual connectivity (DC) when the UE is simultaneously in RRC_CONNECTED mode with multiple networks.

32. The method according to claim 28, further comprising checking a condition to trigger sending the assistance information to the network node.

33. The method according to claim 32, wherein the condition defines a change in a channel condition and/or a change of data demands.

34. The method according to claim 28, wherein the assistance information comprises one or more of the following:
an indication of UE preference to have one or more serving cells activated;
an indication of UE preference to have one or more serving cells deactivated;
an indication of a reduced configuration that the SCG is allowed to configure;
an indication of preferred UE power class as part of the reduced UE configuration to enable the UE to perform Multi-SIMs operation.
an indication of UE preference of preferred maximum uplink duty cycle as part of the reduced UE configuration to enable the UE to perform Multi-SIMs operation.
an indication indicating that the UE can perform Multi-SIMs operation while still being configured with multi radio access technology (MR)-dual connectivity (DC) provided that the SCG is deactivated.

35. A method performed by a network node associated with a wireless communications network, the method comprising
receiving assistance information from a user equipment (UE), wherein the assistance information is related to a master cell group (MCG) and/or a secondary cell group (SCG) and the assistance information indicates a preference for reduced UE configuration for Multi-Subscriber Identity Modules (SIM) purposes.

36. A user equipment (UE) comprising:
at least two Subscriber Identity Modules (SIM) for simultaneous communication with two or more networks; and
processing circuitry configured to provide assistance information to a network node, wherein the assistance information is related to a master cell group (MCG) and/or a secondary cell group (SCG) and the assistance information indicates a preference for reduced UE configuration for Multi-SIMs purposes.

37. The UE according to claim 36, wherein the UE is configured to transmit the assistance information to the network node in response to one or more of:
availability of information to be sent in a first request that is different from information previously sent in a prior request to the network node concerning a reduced set of capabilities;
an occurrence of an event;
an occurrence of one or more network-configured conditions;
a handover of the UE from a source cell to a target cell;
a reconfiguration procedure other than a handover;
a connection setup;
a re-establishment procedure;
a resume procedure;
before the UE is moved to RRC_INACTIVE;
for a UE that is configured to provide assistance information on reduced UE configuration for Multi-SIMs purposes, when the UE initiates a Radio Resource Control (RRC) connection re-establishment procedure or when the UE initiates a RRC resume procedure, the configuration related with assistance information on reduced UE configuration for Multi-SIM purposes is released by the UE; and
sending, to another network node, a UE assistance information message that no longer includes an indication of UE preference for a certain reduced UE configuration for Multi-SIM purposes.

38. The UE according to claim 36, wherein the processing circuitry is configured to configure the UE to provide the assistance information and/or configuring the UE with one or more triggering conditions under which the UE is to provide the assistance information.

39. The UE according to claim 38, wherein the processing circuitry is configured to configure the UE to provide the assistance information and/or configure the UE with the one or more triggering conditions by configuring the UE to provide the assistance and/or an indication of triggering provision of an indication of a preference to reduce UE capabilities for Multiple SIMs purposes in multi radio access technology (MR)-dual connectivity (DC) when the UE is simultaneously in RRC_CONNECTED mode with multiple networks.

40. The UE according to claim 36, wherein the processing circuitry is configured to check a condition to trigger sending the assistance information to the network node.

41. The UE according to claim 40, wherein the condition defines a change in a channel condition and/or a change of data demands.

42. The UE according to claim 36, wherein the assistance information comprises one or more of the following:
an indication of UE preference to have one or more serving cells activated;
an indication of UE preference to have one or more serving cells deactivated;
an indication of a reduced configuration that the SCG is allowed to configure;
an indication of preferred UE power class as part of the reduced UE configuration to enable the UE to perform Multi-SIMs operation.
an indication of UE preference of preferred maximum uplink duty cycle as part of the reduced UE configuration to enable the UE to perform Multi-SIMs operation.
an indication indicating that the UE can perform Multi-SIMs operation while still being configured with multi radio access technology (MR)-dual connectivity (DC) provided that the SCG is deactivated.

43. A network node associated with a wireless communications network, wherein the network node comprises:
processing circuitry configured to receive assistance information from a user equipment (UE), wherein the assistance information is related to a master cell group (MCG) and/or a secondary cell group (SCG) and the assistance information indicates a preference for reduced UE configuration for Multi-Subscriber Identity Modules (SIM) purposes.

44. The network node according to claim 43, wherein the assistance information comprises one or more of the following:
an indication of UE preference to have one or more serving cells activated;
an indication of UE preference to have one or more serving cells deactivated;
an indication of a reduced configuration that the SCG is allowed to configure;
an indication of preferred UE power class as part of the reduced UE configuration to enable the UE to perform Multi-SIMs operation.
an indication of UE preference of preferred maximum uplink duty cycle as part of the reduced UE configuration to enable the UE to perform Multi-SIMs operation.
an indication indicating that the UE can perform Multi-SIMs operation while still being configured with multi radio access technology (MR)-dual connectivity (DC) provided that the SCG is deactivated.

45. The network node according to claim 43, wherein the processing circuitry is configured to configure the UE to provide the assistance information and/or an indication of triggering such provision of an indication of preference to reduce UE capabilities for Multiple SIMs purposes in multi radio access technology (MR)-dual connectivity (DC) when the UE is simultaneously in RRC_CONNECTED mode with multiple networks.

46. The network node according to claim 43, wherein the processing circuitry is configured to transmit, to another network node, an indication related to the received assistance information.

47. The network node according to claim 43, wherein the processing circuitry is configured to determine whether to initiate reduction of UE configuration taking the received assistance information and/or an exchanged indication into account.
